(19) United States
(12) Patent Application Publication
(10) Pub. No.: US 2002/0049914 A1
(43) Pub. Date: Apr. 25, 2002

(54) Electronic service system using safe user information management scheme

(75) Inventors: Atsushi Inoue, Kanagawa (JP); Yoshinari Kumaki, Kanagawa (JP); Masahiro Takagi, Tokyo (JP); Atsushi Fukumoto, Kanagawa (JP); Naohisa Shibuya, Saitama (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 09/983,698

(22) Filed: Oct. 25, 2001

(30) Foreign Application Priority Data
Oct. 25, 2000 (JP) P2000-325045

(51) Int. Cl. G06F 11/30

(52) U.S. Cl. 713/201

(57) ABSTRACT

An electronic service system is formed such that the personal authentication information such as user ID and password registered at one site can be utilized in carrying out the electronic commerce or the electronic service at another site, by transferring the user information between a plurality of EC sites safely.

### BACKGROUND OF THE INVENTION

1. Field of the Invention

The present invention relates to an electronic service system for realizing the electronic commerce on network such as the Internet.

2. Description of the Related Art

Many of the electronic shop or electronic commerce systems and electronic services (information retrieval, portal site, electronic bulletin board, etc.) on the Internet are constructed on a basis of the WWW (World Wide Web) system. On the client computers to be used by users of these electronic shops and electronic services, a software called WEB browser (or simply browser) is operated. The user makes an access from the WEB browser to a server computer of the electronic shop at which the purchase of goods through the Internet is desired or a server computer that provides the desired electronic service, and carries out viewing of goods information, goods purchase procedure, information retrieval, information exchange, etc.

On the server computer, a program for executing functions of the electronic shop or the electronic service is operated, to carry out the sales processing such as presentation of goods description or price to a customer, inventory check upon receiving an order from a customer, payment processing, and delivery arrangement, etc., for example. There are also cases where the server computer manages the past transaction logs according to the user information of the customers and provides services such as goods recommendation suitable to each customer and discount sales. The server computer may also carry out communications with computers of the other service companies as in the case of credit card settlement, for example.

The WEB browser on the client computer and the electronic shop or electronic service program on the server computer carry out communications using a WWW standard communication protocol called HTTP. In the HTTP protocol, a set of request and reply is used as a basic unit of communications such that when a request containing an identifier of the processing request called URL and any necessary information associated with that request is sent, a reply containing data such as HTML document for displaying the processing result will be returned. In the electronic commerce, the request is sent from the client computer toward the server computer, and the reply is sent from the server computer toward the client computer.

Usually, in the electronic commerce on the Internet, the user authentication is carried out to fulfill the need related to the security. In the user authentication, a password specific to the electronic shop or electronic service is used to verify that it is a legitimate user, and then an access to a menu on the server computer is permitted. Here, the user information is utilized not only for judging whether or not to permit an access by the user, but also for obtaining the user specific preference information based on the past access logs as mentioned above or for controlling preferential treatment according to a user class. Also, the more strict user authentication is necessary especially in the case of charging an amount to be paid for the purchased goods in the electronic commerce, in order to deal with the illegal act such as the pretending by the malicious user.

For these reasons, the user authentication is a practically indispensable technical feature of a WEB site for carrying out the electronic commerce (EC) or the electronic service at present.

On the other hand, such a user authentication is associated with several problems such as the following.

Problem 1: It is tedious for a user.

It is hardly a matter if the user only uses a small number of EC sites, but in the case where the user makes accesses to many sites, there is a problem that it is difficult to manage the correct user ID and password pairs. In general, when the user subscribes to the EC site, a user ID is issued after the check for avoiding any overlap with the IDs of the already subscribed members. For this reason, there is no guarantee that a single user can use the same user ID at every EC site. Also, it is preferable to frequently change the password from a viewpoint of the security, but it is practically difficult to change the passwords at a plurality of EC sites all at once, and it is also not preferable to manage accesses by issuing a user ID and a password at each site from a viewpoint of the security management.

Problem 2: Sites are not trustworthy so that there is a desire to minimize disclosure of personal information.

Next, there is a problem regarding whether the user can trust all the sites or not. In particular, the leakage of the user information is becoming a major social concern recently, and from a viewpoint of the user, there is a desire to register the user's own personal information only at the minimum number of EC sites that are sufficiently trustworthy.

Problem 3: There is a problem on the site operating side.

For the EC site operating side, when the number of registered users or the number of operating sites becomes large, it is preferable to be able to realize a distributed management of the user information from a viewpoint of the cost for facility investment or the like. In particular, in the case of mutually providing products among a plurality of sites in order to increase the marketing effect or the case of distributing user entrances by introducing systematized sites due to the increased site scale, the separate management of the user information at each site or entrance would be inappropriate from viewpoints of the user convenience and the EC site management.

Thus, the user authentication has been a practically indispensable technical feature of a WEB site for carrying out the electronic commerce (EC) or the electronic service conventionally, but the user management has been realized by using a database containing the user ID and the password that are unique for each EC site so that it has been necessary for the user to enter the user ID and the password that are separately set up for each EC site whenever the accessed EC site is changed, and therefore there are problems related to the user convenience and the personal information management. In addition, there has been a problem on the site operating side in that the facility investment according to the size of the users is required for the user authentication database.

### BRIEF SUMMARY OF THE INVENTION

It is therefore an object of the present invention to provide an electronic service system in which the personal authentication information such as user ID and password registered at one site can be utilized in carrying out the electronic commerce or the electronic service at another site, by transferring the user information between a plurality of EC sites safely.

It is another object of the present invention to provide an electronic service system capable of suppressing the leakage of the user information to the minimum, by transferring the authentication information of a given user to a trustworthy third party through a third site according to the need, and carrying out the user authentication, the user attribute extraction and the feedback of a part of that information to the EC site at the third party side.

According to one aspect of the present invention there is provided a user information management device, connected to a server computer for providing an electronic shop and/or an electronic service on a network, for managing information of a user who utilizes the electronic shop and/or the electronic service, the user information management device comprising: a user information communication unit configured to receive a user identification information transmitted from a client computer used by a user who utilizes the electronic shop and/or the electronic service, and return an authentication result to the client computer; a message analysis unit configured to carry out a search of one user information management device at which the user is registered and one server computer connected to said one user information management device according to an affiliation information of the client computer contained in the user identification information, and carry out an authentication of the user by matching the user identification information with a database of the user information management device to obtain the authentication result to be returned by the user information communication unit, when the user is registered at the user information management device itself as a result of the search; and a user information transfer unit configured to establish a secure communication path between the user information management device and another user information management device when the user is registered at said another user information device as a result of the search, transfer the user identification information to said another user information management device through the secure communication path so as to request the authentication of the user to said another user information management device, and receive the authentication result to be returned by the user information communication unit from said another user information management device in response.

According to another aspect of the present invention there is provided an electronic service system comprising a server computer for providing an electronic shop and/or an electronic service on a network, a user information management device connected to the server computer, and a client computer to be used by a user who utilizes the electronic shop and/or the electronic service; wherein the client computer transmits a user identification information to the user information management device, the user identification information containing at least an affiliation information that indicates a desired server computer that provides the electronic shop and/or the electronic service requested by the user and an information for identifying the user on the desired server computer, and receives an authentication result for the user from the user information management device; and the user information management device includes: a user information communication unit configured to receive the user identification information transmitted from the client computer, and return the authentication result to the client computer; a message analysis unit configured to carry out a search of one user information management device at which the user is registered and one server computer connected to said one user information management device according to the affiliation information of the client computer contained in the user identification information, and carry out an authentication of the user by matching the user identification information with a database of the user information management device to obtain the authentication result to be returned by the user information communication unit, when the user is registered at the user information management device itself as a result of the search; and a user information transfer unit configured to establish a secure communication path between the user information management device and another user information management device when the user is registered at said another user information device as a result of the search, transfer the user identification information to said another user information management device through the secure communication path so as to request the authentication of the user to said another user information management device, and receive the authentication result to be returned by the user information communication unit from said another user information management device in response.

According to another aspect of the present invention there is provided a user information management method in a user information management device for managing information of a user of a server computer that provides an electronic shop and/or an electronic service on a network, the user information management method comprising: receiving a user identification information transmitted from a client computer used by a user who utilizes the electronic shop and/or the electronic service; carrying out a search of one user information management device at which the user is registered and one server computer connected to said one user information management device according to an affiliation information of the client computer contained in the user identification information; carrying out an authentication of the user by matching the user identification information with a database of the user information management device to obtain an authentication result, when the user is registered at the user information management device itself as a result of the search; establishing a secure communication path between the user information management device and another user information management device when the user is registered at said another user information device as a result of the search; transferring the user identification information to said another user information management device through the secure communication path so as to request the authentication of the user to said another user information management device, and receiving the authentication result from said another user information management device in response; and returning the authentication result to the client computer.

According to another aspect of the present invention there is provided a computer usable medium having computer readable program codes embodied therein for causing a computer to function as a user information management device, connected to a server computer for providing an electronic shop and/or an electronic service on a network, for managing information of a user who utilizes the electronic shop and/or the electronic service, the computer readable program codes include: first computer program codes for causing the computer to receive a user identification information transmitted from a client computer used by a user who utilizes the electronic shop and/or the electronic service, and return an authentication result to the client computer; second computer program codes for causing the computer to carry out a search of one user information management device at which the user is registered and one server computer connected to said one user information management device according to an affiliation information of the client computer contained in the user identification information, and carry out an authentication of the user by matching the user identification information with a database of the user information management device to obtain the authentication result, when the user is registered at the user information management device itself as a result of the search; and third computer program codes for causing the computer to establish a secure communication path between the user information management device and another user information management device when the user is registered at said another user information device as a result of the search, transfer the user identification information to said another user information management device through the secure communication path so as to request the authentication of the user to said another user information management device, and receive the authentication result from said another user information management device in response.

Other features and advantages of the present invention will become apparent from the following description taken in conjunction with the accompanying drawings.

### BRIEF DESCRIPTION OF THE DRAWINGS

FIG. 1 is a schematic diagram showing an exemplary network configuration of an electronic service system according to one embodiment of the present invention.

FIG. 2 is a block diagram showing an exemplary configuration of a user information management device in the electronic service system of FIG. 1.

FIG. 3 is a diagram showing an exemplary format of a user information to be exchanged between a server and a client in the electronic service system of FIG. 1.

FIG. 4 is a sequence chart for message exchanges between two user information management devices in the electronic service system of FIG. 1.

FIG. 5 is a sequence chart for message exchanges among user information management devices and an agency site in the electronic service system of FIG. 1.

FIG. 6 is a schematic diagram showing an exemplary configuration using more than one agency sites in the electronic service system of FIG. 1.

FIG. 7 is a schematic diagram showing an exemplary configuration using agency sites in a hierarchical relationship in the electronic service system of FIG. 1.

FIG. 8 is a diagram showing an exemplary format of a user information to be exchanged in the case of using more than one agency sites in the electronic service system of FIG. 1.

FIG. 9 is a schematic diagram showing an exemplary configuration of an electronic service system according to one embodiment of the present invention in which two EC sites have a direct partnership.

FIG. 10 is a flow chart for a cooperative authentication and accounting processing between two EC sites in the electronic service system of FIG. 9.

FIG. 11 is a schematic diagram showing an exemplary configuration of an electronic service system according to one embodiment of the present invention in which two EC sites have partnerships with a common agency site.

FIG. 12 is a flow chart for an authentication and accounting processing between two EC sites via the agency site in the electronic service system of FIG. 11.

FIG. 13 is a diagram showing one exemplary partner site information page that can be used in the electronic service system of FIG. 1.

FIG. 14 is a diagram showing another exemplary partner site information page that can be used in the electronic service system of FIG. 1.

FIG. 15 is a diagram showing one exemplary agency site information page that can be used in the electronic service system of FIG. 1.

FIG. 16 is a diagram showing one exemplary site information page for one agency site that can be used in the electronic service system of FIG. 1.

FIG. 17 is a diagram showing one exemplary available partner site information page that can be used in the electronic service system of FIG. 1.

FIG. 18 is a diagram showing another exemplary partner site information page that can be used in the electronic service system of FIG. 1.

### DETAILED DESCRIPTION OF THE INVENTION

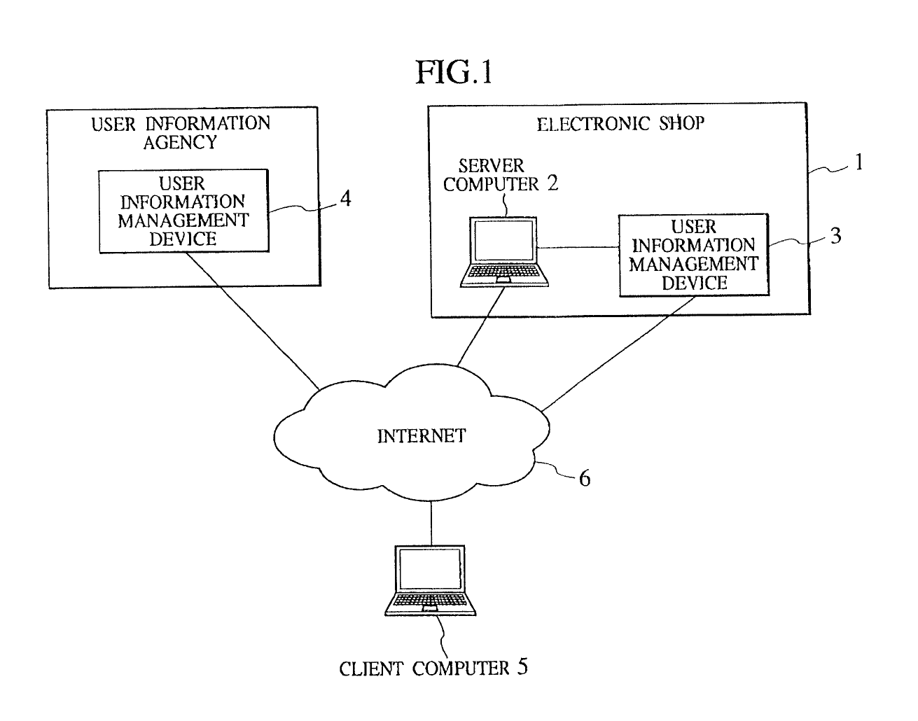

Referring now to FIG. 1 to FIG. 18, one embodiment of the electronic service system according to the present invention will be described in detail.

In the following, the exemplary case of the electronic commerce at an electronic shop or the like on the Internet will be described, but the present invention is also applicable to networks other than the Internet, as well as to systems handling network services such as information providing or transactions/contracts not within the category of the electronic commerce.

FIG. 1 shows an exemplary network configuration of the electronic service system according to this embodiment.

This electronic commerce system comprises server computers 2 (only one is shown in FIG. 1) of a plurality of electronic shop service providers and a user information management device 3 associated with each server computer 2 that constitute an electronic shop 1 in a form of an electronic virtual shop, user information management devices 4 (only one is shown in FIG. 1) of a plurality of user information agencies, and a plurality of client computers 5 (only one is shown in FIG. 1) of users for utilizing the electronic shop service, all of which are connected through the Internet 6.

In general, WEB pages indicated by the URL (Uniform Resource Locator) at which the electronic shop 1 is provided, a server computer that provides these WEB pages, and the other server computers that provide related services will be collectively referred to as a site, but here, the server computer 2 for realizing the actual service or electronic shop will also be referred as a site for the sake of convenience.

In the following, the user refers to a user of the client computer 5. The user utilizes the electronic shop service on the Internet 6 as a customer, and operates the client computer 5 for the purpose of carrying out a desired transaction (i.e., for the purpose of making a desired bilateral contract in which the user usually has a financial obligation for payment of fees or the like) such as that of purchasing goods, ordering home delivery service, reserving a seat or a room, renting something, etc.

On the client computer 5 to be used by the user in order to utilize the electronic shop service, the WEB browser is operated. The user utilizes the electronic shop service (carries out goods information viewing or goods purchasing procedure, for example) by accessing the desired server computer 2 that provides the desired electronic shop service from which the user wishes to purchase goods, for example, from the WEB browser through the Internet, and repeating operations such as viewing a page screen displayed on the WEB browser, entering data according to the need, and pressing various buttons (through the exchanges between both computers by transmitting various requests and receiving replies). Of course, it is also possible to use software or the like that is dedicated to the utilization of the electronic shop service instead of the WEB browser, but the exemplary case of using the WEB browser will be described in this embodiment.

Also, the client computer 5 has a mechanism for carrying out communications with the other computers (the server computer 2, the user information management device 3, the user information management device 4 of the user information agent, etc.) through the Internet 6 (such as communication software and communication interface device, for example).

Note that the client device 5 can be connected to the Internet 6 either via the Internet service provider (not shown) or without using the Internet service provider.

On the server computer 2, the electronic shop program is operated to provide various electronic shop services of that site such as the sales processing including the presentation of descriptions and prices of goods or service contents, the inventory checking upon receiving an order from the user, the payment processing, and the delivery arrangement in the case of the goods sales service site, for example, with respect to the user of the client computer 5. The electronic shop program on the server computer 2 carries out the processing while managing necessary information such as information regarding goods catalog, information regarding inventory, information regarding individual transaction content, and information regarding actual payment and delivery, in a database.

Also, the server computer 2 has a mechanism for carrying out communications with the user information management device 3, the user information management device 4 of the user information agency, and the client computer 5 (such as communication software and communication interface device, for example).

The user information management device 3 in this embodiment receives the identification information of the user of the electronic shop site (user identification information) either via the server computer 2 or directly from the client computer 5. Then, the user information management device 3 judges whether or not that user can utilize the electronic shop site with which this user information management device 3 is associated. When that user can utilize the electronic shop site, the user information management device 3 also judges a user entity to which fees should be charged.

Also, the user information management device 3 has a mechanism for carrying out communications with the server computer 2, the client computer 5, the user information management device 4 of the user information agency, and the other user information management device 3 (such as communication software and communication interface device, for example).

In particular, there is a need to carry out safe communications for the user information so that it is assumed that the appropriate network security mechanism (such as SSL (Secure Sockets Layer), IPsec, etc.) is available (although devices with which the communications using the security function are possible will be determined according to the contract relationship and the management policy among sites).

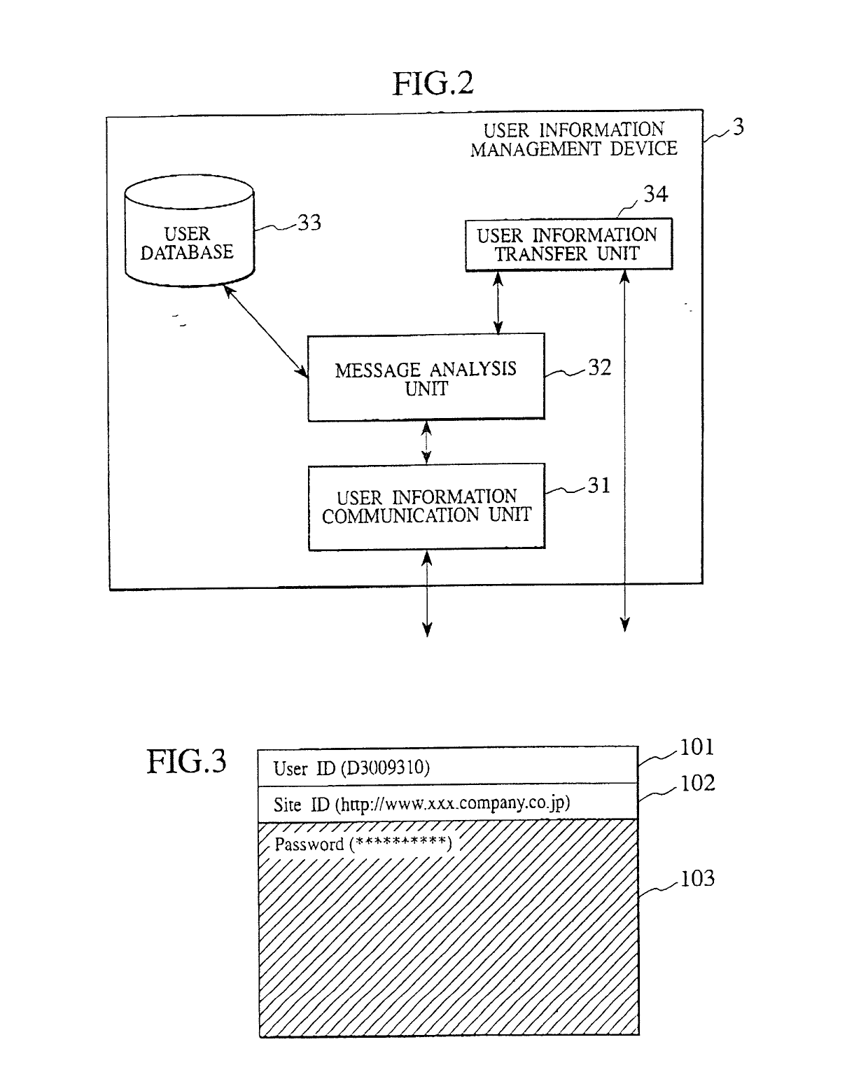

FIG. 2 shows an exemplary configuration of the user information management device 3 in this embodiment.

The user information management device 3 comprises a user information communication unit 31 for receiving a user information message transferred from the server computer 2 or the client computer 5 and returning a response, a message analysis unit 32 for analyzing the user information message, a user database 33 for storing the user information to be managed by the user information management device 3, and a user information transfer unit 34 for transferring the user information message to the other user information management device 3 or the user information management device 4 of the user information agency according to the analysis made by the message analysis unit 32.

The user information management device 3 receives information (user identification information) such as an identifier of the user, information indicating a site at which the user made the membership registration, a password to be used at a time of utilizing the electronic shop site, etc., from the server computer 2 or the client computer 5. This information is related to the privacy of the user so that it is preferable to carry out the transfer after applying the encryption or the like.

As will be described in detail below, there are various methods for realizing a mechanism to be used for the transfer of this information, including a method for providing a user information input page that is protected by the SSL or the like on the server computer 2, a method for carrying out communications after encrypting the user information that is set up at a terminal in advance by using a special mechanism from the client computer 5, and a method for transferring information read out from an external memory device such as IC card or SIMM card in which the user information is stored, for example.

A format of the user information message (user identification information) to be transferred can be predetermined between the user information management device 3 and the server computer 2 or the client computer 5. For example, a message as shown in FIG. 3 can be transferred, where each field is set up as follows.

User ID 101: a user ID used at the membership registered site

Site ID 102: an identifier of the membership registered site. This identifier can be provided by an identifier that is uniquely defined among a plurality of sites, or a domain name of the URL, for example.

Password 103: a password set up by the membership registration, which apparently should be encrypted.

The received user information message is sent to the message analysis unit 32. At the message analysis unit 32, the site ID is checked first, and then whether the user is a member or not is checked. If the user is a member, the user information message is compared with the contents of the user database 33, and if the user is a proper user, the utilization permission message is returned.

Here, if the site ID is that of the other electronic shop, the received user information message is transferred to the user information management device 3 associated with that other electronic shop, so as to entrust the processing regarding the user authentication and the accounting. Then, a message indicating the result of the entrusted processing is received, and a utilization permission (or refusal) message is returned.

As for a relationship between the electronic shop that is currently in communication and the other electronic shop indicated by the site ID, the following three cases are possible.

(1) They have a close partnership with each other, and the security parameter information required for safely exchanging the authentication/accounting information is already exchanged between them. In this case, a communication path capable of exchanging information safely between them is already established.

(2) They have partnerships with a common agency site, and the security parameter information required for safely exchanging the authentication/accounting information of each one of them is already exchanged with that agency site, so that they are capable of exchanging messages via that agency site. In this case, a communication path capable of exchanging information safely between each one of them and the agency site is already established.

(3) They have no partnership.

In the case (3), it suffices to return the authentication impossible message immediately.

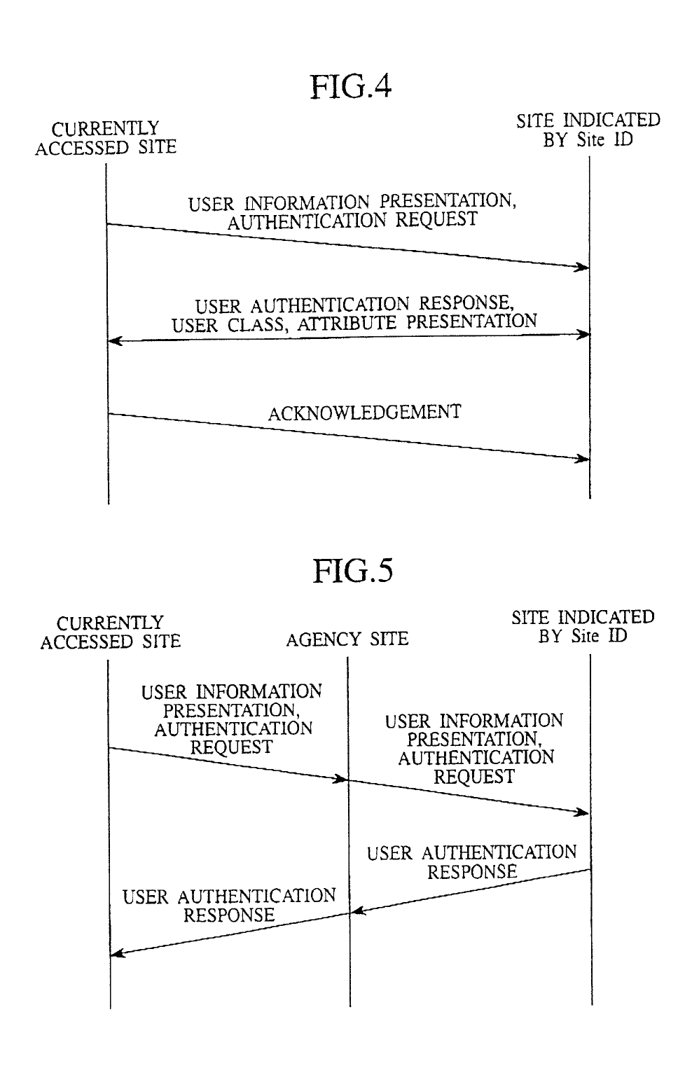

In the case (1), the message transfer as described above will be carried out. The message transfer protocol can be suitably set up between the user information management devices, and it suffices to exchange a request message and a response message as shown in FIG. 4, for example.

In FIG. 4, the user information management device of the currently accessed site presents the user information for the user authentication, and requests the authentication. In response, the user information management device of the site indicated by the site ID carries out the authentication processing, and the authentication response is presented along with the user class and the attribute information such as an option service contract. Upon receiving this, an acknowledgement (ACK) is returned.

In the case (2), messages are transferred to the agency site. Here, the agency site is operated by an operator who is sufficiently trustworthy for both electronic shops, such as the credit company, for example. As for a protocol for the message exchange with the agency site, that shown in FIG. 4 may be used as it is, or separate protocols may be set up as shown in FIG. 5, for example.

FIG. 5 shows an exemplary case of exchanging only the authentication request and the authentication response via the agency site.

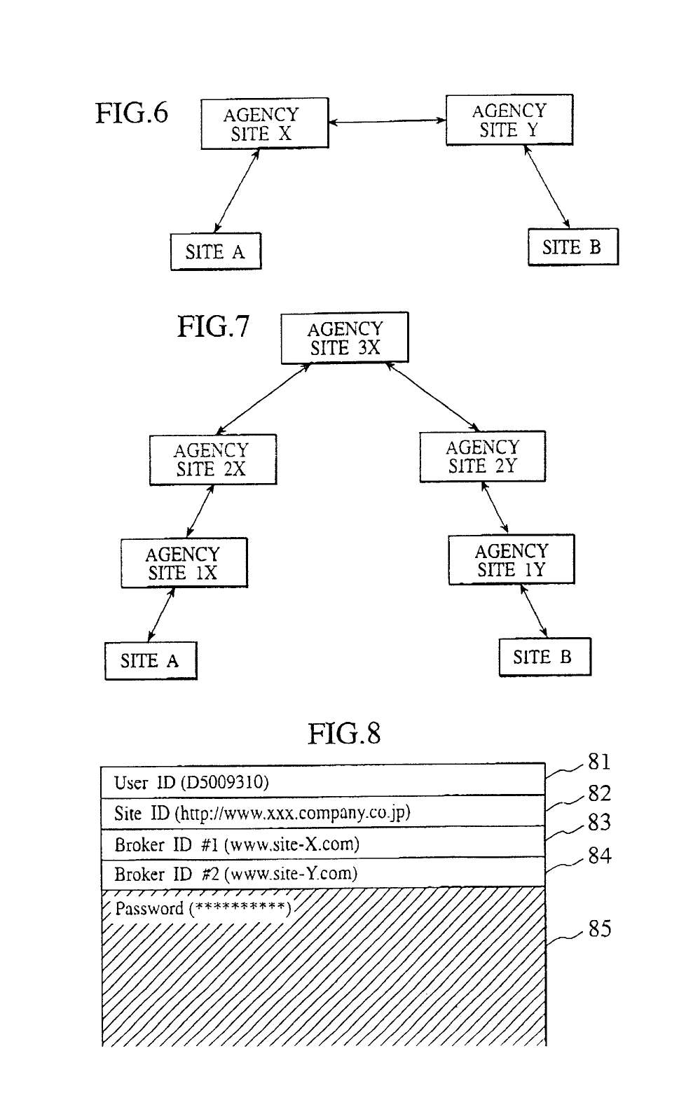

Note that it is possible to transfer messages via a plurality of agency sites as shown in FIG. 6, and it is also possible to use the agency sites in a hierarchical configuration as shown in FIG. 7. In either case, there are several possible methods for transferring a message destined to the destination user information management device through an appropriate route.

One method is to specify that it should be transferred via devices in plural stages by expanding a format of the exchange message. For example, in the case shown in FIG. 6, the message transfer processing can be realized as follows. Namely, the agency site Y having a partnership with the user's subscribed site B is specified from the current electronic shop site A first, and the existence of the agency site X having a partnership with the agency site Y is searched. Then, the message as shown in FIG. 8 is transmitted through these agency sites.

A message shown in FIG. 8 contains a user ID 81 for identifying the user, a site ID 82 to which the access should be made, broker IDs (agency site IDs) 83 and 84 for indicating agency sites, and a password 85 corresponding to the user ID 81.

Also, in the hierarchical configuration shown in FIG. 7, the message transfer processing can be realized as follows. Namely, an information server for managing the partnerships among sites is provided, and inquiry to this information server is made by specifying the number of hierarchical steps for which the partnerships should be searched, according to the URLs of the destination and current sites. Then, the message is transferred via the agency sites obtained as a result of the inquiry.

In the following, the electronic service system according to this embodiment will be described in further detail for a concrete exemplary case of purchasing some goods by utilizing the electronic shop. Here, the user makes a log-in to the system by using a “user information input button” on the system, and selects some of a plurality of “goods selection buttons”. Finally, the payment of the fees is carries out by any one of several payment methods provided by the system, using a “fee payment button”.

These buttons may be named more appropriately according to the nature of the site. For example, in the case of the airplane ticket reservation site, a button named “flight reservation button” may be used. The same applies to any other electronic services.

It is also possible to use GUI parts other than buttons may be used. It is also possible to use the input by speech instead of or in addition to the GUI parts.

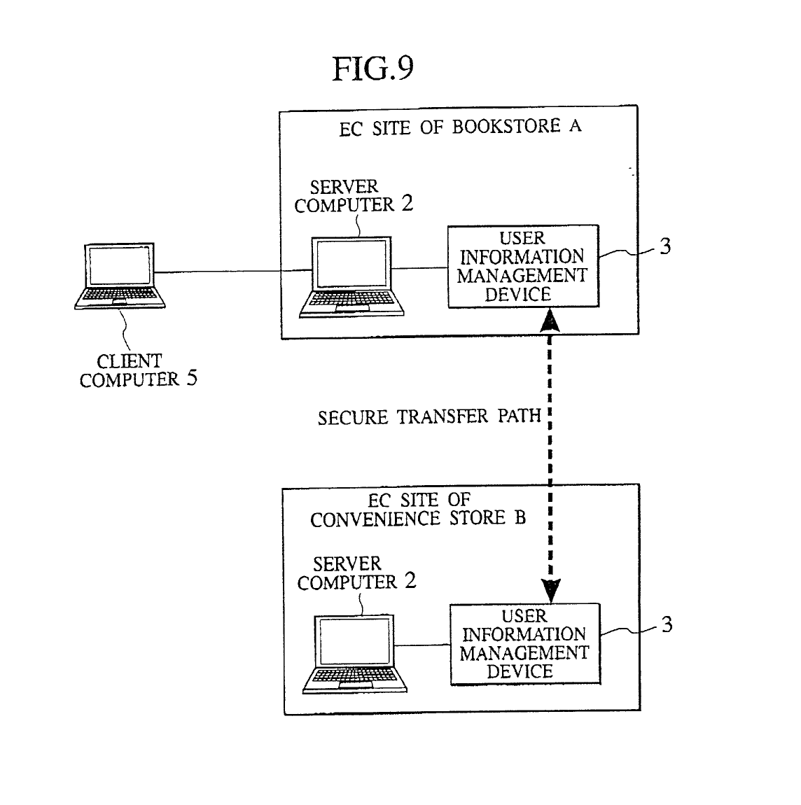

More specifically, as shown in FIG. 9, the exemplary case where some user Y operates the WEB browser on his own client computer 5 to access the server computer 2 of the EC site of the bookstore A will be considered. Here, it is assumed that the user Y has not made a membership registration for the bookstore A itself, but has a membership qualification for an EC site operated by the other convenience store B.

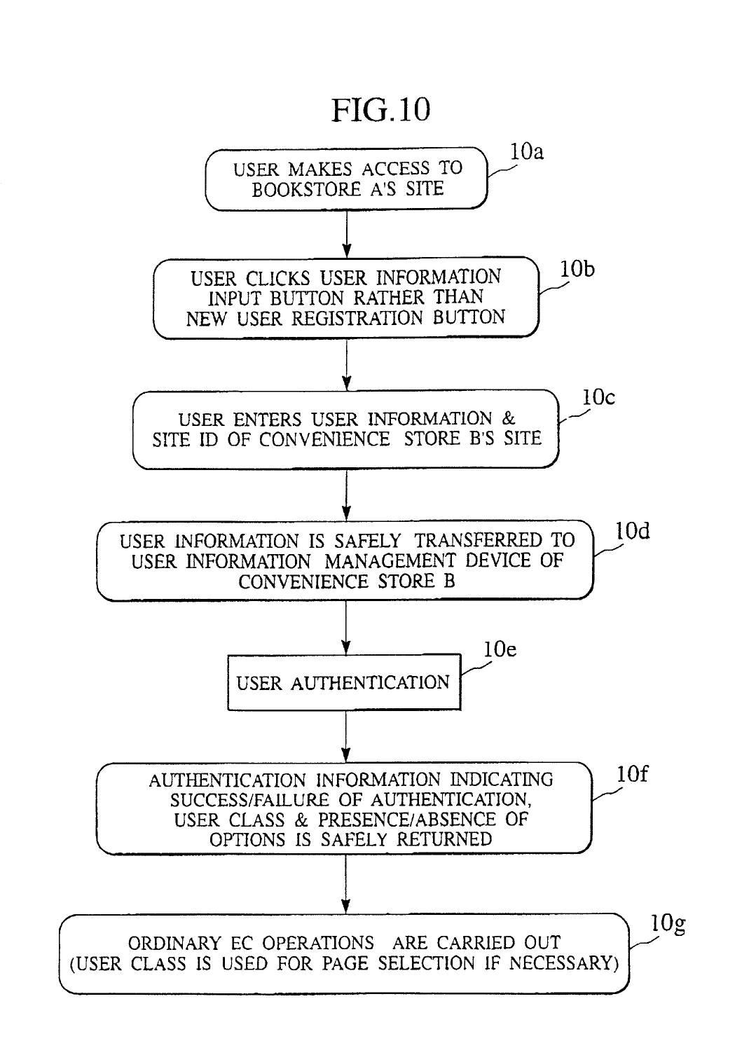

In this case, the processing is carried out according to FIG. 10 as follows. Namely, the user Y accesses the EC site of the bookstore A (step 10a) and clicks a “user information input button” to be used by the already registered user rather than a “new user registration button” at an entrance page of the bookstore A (step 10b). At the next page, the user enters the user ID and the password that are registered as a member at the convenience store B, as the user information, along with the site ID indicating the EC site of the convenience store B (step 10c).

After this information is sent to the user information management device of the bookstore A side, this information is safely transferred to the user information management device of the EC site of the convenience store B using a mechanism such as encryption (step 10d), and the user authentication to check the membership qualification is carried out there (step 10e).

In this user authentication, not only whether the user is allowed to receive the service or not is checked, but also the user class and the presence or absence of the option service (such as whether the user has a qualification for the service option of picking up goods at the convenience store or not, for example) is checked, and the result will be reflected in the subsequent service menu display. This can be realized by the processing for automatically jumping to a start page for users in the user class 1 with options, for example (step 10f).

After the user is authenticated at the convenience store B side, the user makes purchases of books by clicking goods selection buttons just like an ordinary member of the bookstore A (step 10g).

The final accounting can also be made similarly as the ordinary user if the user intends to use the accounting method provided at the EC site of the bookstore A. Alternatively, in the case where the user intends to use the credit card or electronic money that is already registered at the convenience store B in advance, the accounting data at the bookstore A must be transferred to the convenience store B. Here, it is important to guarantee the security using encryption or the like for the transfer of this accounting data, similarly as in the initial transfer of the user information.

Note that, in the electronic commerce, the profile information such as the purchase log of each user is very important from a viewpoint of marketing, and whether the action log of the user Y at the bookstore A should be notified to the convenience store B or not can be determined by the operation policy between these sites. In the case of notifying the action log to the convenience store B, it suffices to carry out the security communication at a timing of the session end similarly as the accounting data described above.

Such a cooperation using the user information transfer among two or more EC sites of different business categories has the following advantages.

A range of goods that can be purchased or a variation of services that can be received by a single membership qualification can be enhanced, so that the better customer satisfaction can be expected.

Types of users who can utilize a given EC site can be enhanced as the accounting method that cannot be supported at the given EC site is made available via the partner site.

By exchanging the user profiles with each other, it becomes possible to acquire the user trends in a wider range and realize the marketing based on many user information.

This cooperation between EC sites can be useful not only for EC sites of different business categories as described above, and it is also possible to consider the cooperation between EC sites of the same business category. A typical example is the case where the regional information providing service sites are separately provided at different regions. In this case, it is possible to operate the EC sites such that a user X who made the user registration at Tokyo area can freely log-in to the partner sites of the other regions as well, for example. The method for exchanging the authentication messages can be basically the same as described above. The cooperation of this kind can have the following advantages.

The number of potential users can be increased by this cooperation among sites. This has an effect of increasing the number of viewings (the number of times for which it is viewed by the users) in the case of the site operation based on the advertising revenue, so that there is an effect of increasing the advertising revenue at both sites.

In the case of the regional sites as described above, it is expected that users of the central site that has opened earlier will become users of the regional sites as well. In this case, the number of users for which the authentication and accounting processing should be carried out can be reduced compared with the case of making the user registration again at each regional site. This is convenient for the regional site which generally has a smaller scale of investment compared with the central site. By using this cooperation among sites, the outsourcing in which the store design is made by the regional site while the authentication and accounting infrastructure is supported by the central site can be realized in a natural form.

Thus this cooperation on the user authentication and accounting among sites of the same field can be an effective way not only for realizing the cooperation among enterprises but also for realizing the regional expansion of the EC sites or the franchised chain stores.

Next, the exemplary case of carrying out the user information exchange via the third agency site will be described.

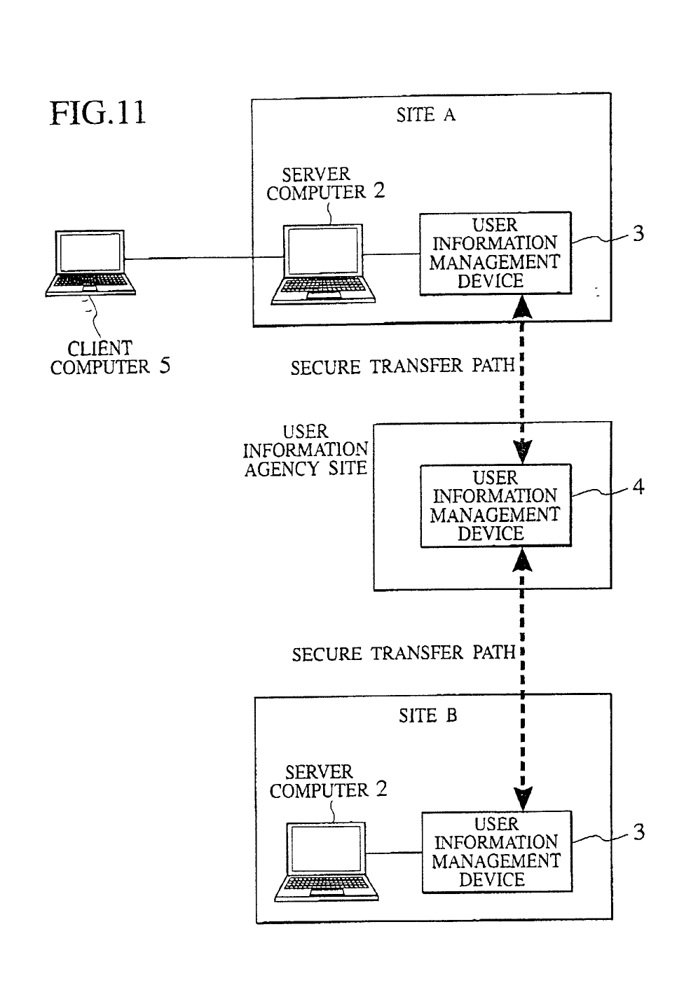

More specifically, as shown in FIG. 11, the exemplary case where some user Z operates the WEB browser on his own client computer 5 to access the server computer 2 of the site A will be considered. Here, it is assumed that the user Z has not made a membership registration for the site A itself, but has a membership qualification for the other site B. It is also assumed that there is no direct partnership between the site A and the site B so that data cannot be exchanged safely between the user information management devices unlike the case of FIG. 9.

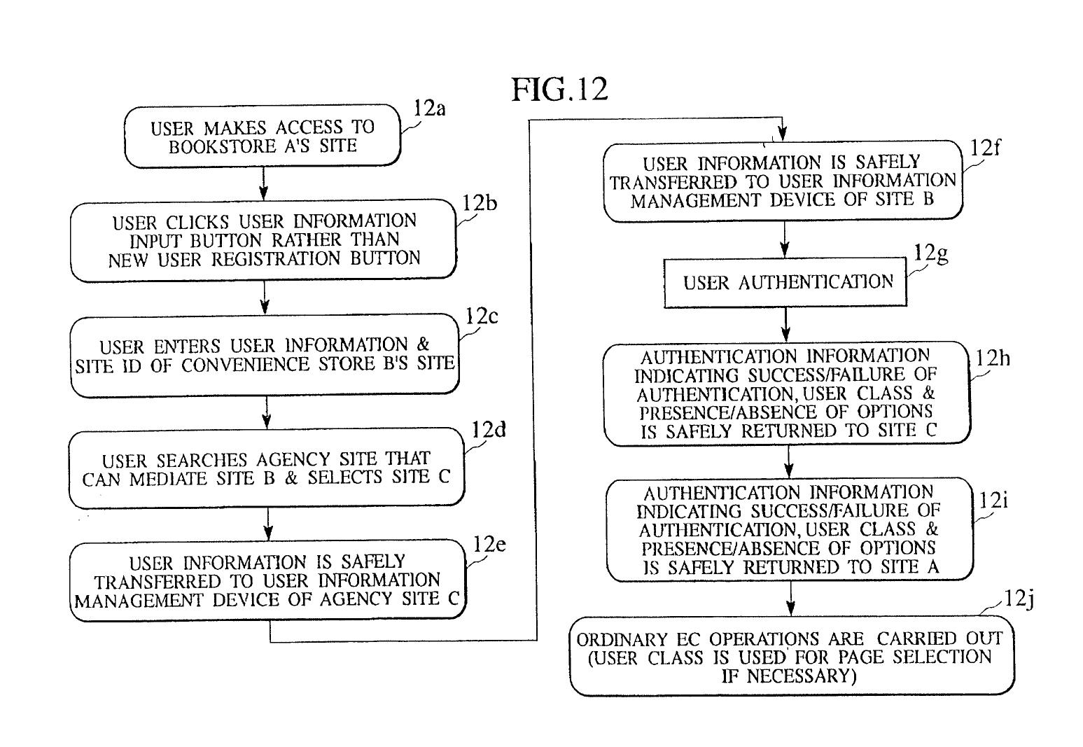

In this case, the processing is carried out according to FIG. 12 as follows. Namely, the user Z accesses the site A (step 12a) and clicks a “user information input button” to be used by the already registered user rather than a “new user registration button” at an entrance page of the site A (step 12b). At the next page, the user enters the user ID and the password that are registered as a member at the site B, as the user information, along with the site ID indicating the site B (step 12c).

here, there is no direct partnership between the site A and the site B, so that the site A inquires whether the relaying to the site B is possible or not to each agency site having a partnership with the site A. This can be done by sequentially sending messages to the agency sites, or by inquiring to a server managing the partnerships of the agency sites by presenting a list of partner agency sites of the site A and the identifier of the site B. Here, it is assumed that the agency site C is selected in this way (step 12d).

After the entered information is sent to the user information management device of the site A, this information is safely transferred to the user information management device of the agency site C using a mechanism such as encryption (step 12e). Then, this information is safely transferred to the user information management device of the site B similarly through an encrypted transfer path (step 12f), and the user authentication to check the membership qualification is carried out there (step 12g).

In this user authentication, not only whether the user is allowed to receive the service or not is checked, but also the user class and the presence or absence of the option service is checked, and the result will be reflected in the subsequent service menu display. This can be realized by the processing for automatically jumping to a start page for users in the user class 1 with options, for example (step 10f).

After the user is authenticated at the site B side, a message indicating the service availability is transferred by the route of site B → agency site C → site A (steps 12h, 12i). After the authentication, the user makes purchases of goods by clicking goods selection buttons just like an ordinary member of the site A (step 12j).

In the case where the user intends to use the credit card or electronic money that is already registered at the site B in advance, the accounting data at the site A must be transferred to the site B, and this is done by guaranteeing the security using encryption or the like, through the agency site C, similarly as in the initial transfer of the user information. The user log information at the site A can be handled similarly.

Note that the agency site can be provided for free by a credit card company under the condition of using the card of that credit card company at both sites, but it is also possible to collect some agency fee because some investment to the information infrastructure is necessary in order to provide such an agency site in general. In the latter case, the agency site that requires the lower agency fee is preferable from a viewpoint of the user. The method of selecting such a preferable agency site will be described below.

Now, the cooperation on the user authentication and accounting among EC sites as described above (which will be referred to as roaming hereafter) is not necessarily mandatory, and the following variations are possible.

The cooperation among sites is made available when a certain handling fee is paid at the currently accessed site.

In practice, the user does not make any payment directly to the site A so that it is difficult for the site A to collect the handling fee directly from the user, but an amount including the roaming handling fee can be charged to the user and the adjustment between the sites can be made later on according to the log (in which case the handling fee is to be paid by the user), or the roaming handling fee can be deducted from the fee for goods (in which case the handling fee is to be paid by the currently accessed site).

The roaming is permitted only to those users who made the roaming option contract at the original membership site.

This is a method in which the transfer of the user information is carried out and the user option is checked as usual, but the utilization of the site is not permitted to those users who have no roaming option contract.

Now, in general, the user can be expected to have the membership contracts with a plurality of sites. Consequently, in the case of receiving service at some site, the best one to be used among a plurality of the membership qualifications can be evaluated in various ways depending on the user's benefit and the network operation policy. For example, it is possible to realize the method for selecting the membership site or the agency site from a viewpoint of the user side, according to the following two criteria.

The extraneous expense such as the handling fee should be reduced as much as possible.

The membership qualification or the agency service of the user's preference should be given a higher priority.

The best membership qualification to be used in utilizing the site for the user is the one for which the handling fee is lowest, so that a list of handling fees of the partner sites of the site to be currently accessed can be acquired and the membership qualification to be used can be selected according to this list.

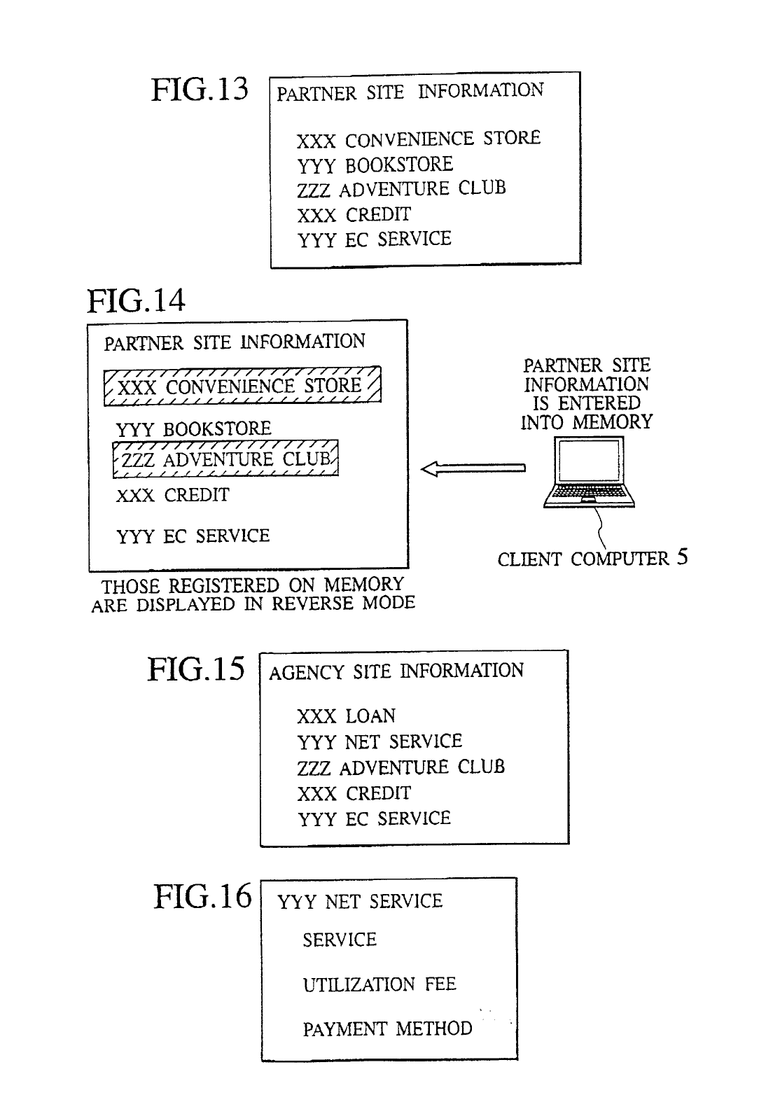

For example, the user can be allowed to make a selection according to the partner site information as shown in FIG. 13, or an information on the registered sites is stored in a memory of the browser or the terminal of the user and the available partner sites are indicated by display in reverse mode as shown in FIG. 14 such that the user is allowed to select one with the lowest handling fee among them.

On the other hand, in the case where the user happens to have no membership qualification for any available partner site after the above procedure, the user can select the agency site. This can be done by providing a list of partner agency sites as shown in FIG. 15, in which a clicking of a link to one partner agency site will cause the display of information on that partner agency site as shown in FIG. 16 (this information may be provided at the WEB site managed by the agency site), or the partner agency sites of the site for which the user has the membership qualification can be searched such that the user is allowed to select one with the lowest agency fee.

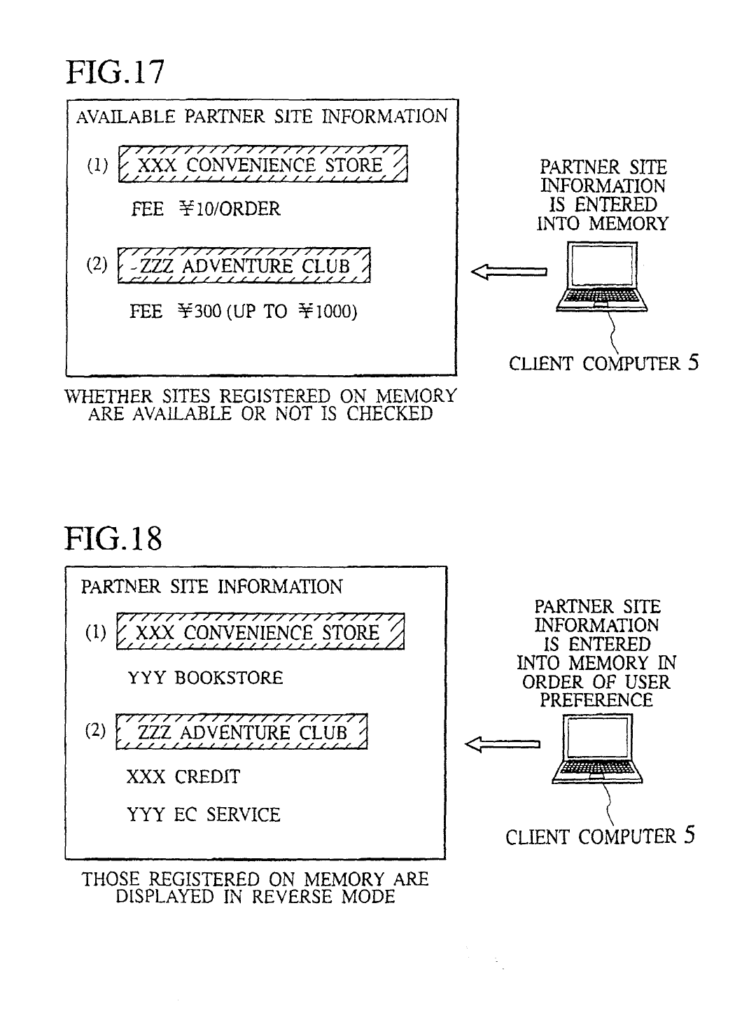

Else, it is also possible to use a method in which the agency sites are automatically circulated using the registered site information stored in a part of the user terminal or the browser as a key, a list indicating whether each agency site is available or not is displayed, and the user is allowed to make a selection from the list as shown in FIG. 17.

On the other hand, in the case where the user has an apparent preference for the site to be utilized, it suffices to register a preference list of the membership sites and the agency sites in some form and allow the user to select a site to be utilized according to this preference list. For example, it is possible to carry out a processing in which the preference information on the registered sites and the agency sites is stored in a part of the user terminal or the browser and whether each of them is available or not is judged sequentially as shown in FIG. 18.

As described according to the present invention, it is possible to realize an electronic service system in which the personal authentication information such as user ID and password registered at one site can be utilized in carrying out the electronic commerce or the electronic service at another site, by transferring the user information between a plurality of EC sites safely.

Also, according to the present invention, it is possible to suppress the leakage of the user information to the minimum and receive the electronic service safely at arbitrary EC site to which the present invention is applied, by transferring the authentication information of a given user to a trustworthy third party through a third site according to the need, and carrying out the user authentication, the user attribute extraction and the feedback of a part of that information to the EC site at the third party side.

Also, according to the present invention, the jobs such as the user authentication and accounting can be entrusted to the other EC site so that it becomes easier to construct the EC site and there is an effect of improving the marketing effect in short time by the mutual cooperation or the franchising among a plurality of sites.

It is to be noted that the above described embodiment according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the user information management device of the above described embodiment can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiment may be made without departing from the novel and advantageous features of the present invention.

Accordingly, all such modifications and variations are intended to be included within the scope of the appended claims.

What is claimed is:

1. A user information management device, connected to a server computer for providing an electronic shop and/or an electronic service on a network, for managing information of a user who utilizes the electronic shop and/or the electronic service, the user information management device comprising:
a user information communication unit configured to receive a user identification information transmitted from a client computer used by a user who utilizes the electronic shop and/or the electronic service, and return an authentication result to the client computer;
a message analysis unit configured to carry out a search of one user information management device at which the user is registered and one server computer connected to said one user information management device according to an affiliation information of the client computer contained in the user identification information, and carry out an authentication of the user by matching the user identification information with a database of the user information management device to obtain the authentication result to be returned by the user information communication unit, when the user is registered at the user information management device itself as a result of the search; and
a user information transfer unit configured to establish a secure communication path between the user information management device and another user information management device when the user is registered at said another user information device as a result of the search, transfer the user identification information to said another user information management device through the secure communication path so as to request the authentication of the user to said another user information management device, and receive the authentication result to be returned by the user information communication unit from said another user information management device in response.

2. The user information management device of claim 1, wherein the user information transfer unit also transfers at least one of an accounting information and a log information of the user regarding a utilization of a service provided by the server computer to which the user information management device itself is connected, to said another user information management device through the secure communication path so as to entrust at least one of an accounting processing and a log information management with respect to the user to said another user information management device.

3. The user information management device of claim 1, wherein when the secure communication path cannot be established, the user information transfer unit transfers the user identification information to an agency computer having established secure communication paths with respect to the user information management device itself and said another user information management device, so as to request the authentication of the user to said another user information management device, and receives the authentication result to be returned by the user information communication unit from said another user information management device in response, via the agency computer.

4. The user information management device of claim 3, wherein the user information transfer unit also transfers at least one of an accounting information and a log information of the user regarding a utilization of a service provided by the server computer to which the user information management device itself is connected, to said another user information management device via the agency computer so as to entrust at least one of an accounting processing and a log information management with respect to the user to said another user information management device.

5. The user information management device of claim 1, wherein the user information communication unit also transfers a list of available server computers that can be selected as said one server computer to the client computer, so as to allow the user to select said another user information management device to which the user identification information is to be transferred and from which the authentication result is to be received by the user information transfer unit.

6. The user information management device of claim 5, wherein the user information communication unit also transfers an information on a cost for transfer through the secure communication path for each available server computer.

7. An electronic service system comprising a server computer for providing an electronic shop and/or an electronic service on a network, a user information management device connected to the server computer, and a client computer to be used by a user who utilizes the electronic shop and/or the electronic service;
wherein the client computer transmits a user identification information to the user information management device, the user identification information containing at least an affiliation information that indicates a desired server computer that provides the electronic shop and/or the electronic service requested by the user and an information for identifying the user on the desired server computer, and receives an authentication result for the user from the user information management device; and
the user information management device includes:
a user information communication unit configured to receive the user identification information transmitted from the client computer, and return the authentication result to the client computer;
a message analysis unit configured to carry out a search of one user information management device at which the user is registered and one server computer connected to said one user information management device according to the affiliation information of the client computer contained in the user identification information, and carry out an authentication of the user by matching the user identification information with a database of the user information management device to obtain the authentication result to be returned by the user information communication unit, when the user is registered at the user information management device itself as a result of the search; and
a user information transfer unit configured to establish a secure communication path between the user information management device and another user information management device when the user is registered at said another user information device as a result of the search, transfer the user identification information to said another user information management device through the secure communication path so as to request the authentication of the user to said another user information management device, and receive the authentication result to be returned by the user information communication unit from said another user information management device in response.

8. The electronic service system of claim 7, wherein the user information transfer unit also transfers at least one of an accounting information and a log information of the user regarding a utilization of a service provided by the server computer to which the user information management device itself is connected, to said another user information management device through the secure communication path so as to entrust at least one of an accounting processing and a log information management with respect to the user to said another user information management device.

9. The electronic service system of claim 7, wherein when the authentication of the user according to the user identification information is carried out by transferring the user identification information through the secure communication path, the user information management device to which the user is currently connected charges a handling fee to the user.

10. The electronic service system of claim 9, wherein the user information management device transfers an accounting information obtained by adding the handling fee to a fee for service and/or goods selected by the user, to said another user information management device, and receives a payment of the handling fee from said another user information management device according to the accounting information.

11. The electronic service system of claim 9, wherein the user information management device transfers an accounting information obtained by subtracting the handling fee from a fee for service and/or goods selected by the user, to said another user information management device.

12. The electronic service system of claim 7, wherein when the secure communication path cannot be established, the user information transfer unit transfers the user identification information to an agency computer having established secure communication paths with respect to the user information management device itself and said another user information management device, so as to request the authentication of the user to said another user information management device and receive the authentication result to be returned by the user information communication unit from said another user information management device in response, via the agency computer.

13. The electronic service system of claim 12, wherein when the authentication of the user according to the user identification information is carried out by transferring the user identification information through the secure communication paths via the agency computer, the agency computer charges a handling fee to the user.

14. The electronic service system of claim 12, wherein at a time of carrying out the authentication of the user according to the user identification information by transferring the user identification information through the secure communication paths via the agency computer, the client computer displays a list of available agency computers having established secure communication paths with respect to the user information management device itself and said another user information management device, along with a handling fee to be charged for a utilization of each available agency computer, so as to allow the user to select the agency computer to be utilized.

15. The electronic service system of claim 7, wherein the client computer displays a list of more than one server computers so as to allow the user to select the desired server computer that provides the electronic shop and/or the electronic service requested by the user, and receives an input of the user identification information corresponding to the desired server computer selected by user from the user.

16. The electronic service system of claim 7, wherein the client computer displays a list of more than one agency computers having partnerships with the desired server computer that provides the electronic shop and/or the electronic service requested by the user so as to allow the user to select one agency computer, and receives an input of the user identification information corresponding to the agency computer selected by user from the user.

17. A user information management method in a user information management device for managing information of a user of a server computer that provides an electronic shop and/or an electronic service on a network, the user information management method comprising:
receiving a user identification information transmitted from a client computer used by a user who utilizes the electronic shop and/or the electronic service;
carrying out a search of one user information management device at which the user is registered and one server computer connected to said one user information management device according to an affiliation information of the client computer contained in the user identification information;
carrying out an authentication of the user by matching the user identification information with a database of the user information management device to obtain an authentication result, when the user is registered at the user information management device itself as a result of the search;
establishing a secure communication path between the user information management device and another user information management device when the user is registered at said another user information device as a result of the search;
transferring the user identification information to said another user information management device through the secure communication path so as to request the authentication of the user to said another user information management device, and receiving the authentication result from said another user information management device in response; and
returning the authentication result to the client computer.

18. The user information management method of claim 17, wherein when the secure communication path cannot be established, the transferring step transfers the user identification information to an agency computer having established secure communication paths with respect to the user information management device itself and said another user information management device, so as to request the authentication of the user to said another user information management device, and receives the authentication result from said another user information management device in response, via the agency computer.

19. A computer usable medium having computer readable program codes embodied therein for causing a computer to function as a user information management device, connected to a server computer for providing an electronic shop and/or an electronic service on a network, for managing information of a user who utilizes the electronic shop and/or the electronic service, the computer readable program codes include:
first computer program codes for causing the computer to receive a user identification information transmitted from a client computer used by a user who utilizes the electronic shop and/or the electronic service, and return an authentication result to the client computer;
second computer program codes for causing the computer to carry out a search of one user information management device at which the user is registered and one server computer connected to said one user information management device according to an affiliation information of the client computer contained in the user identification information, and carry out an authentication of the user by matching the user identification information with a database of the user information management device to obtain the authentication result, when the user is registered at the user information management device itself as a result of the search; and
third computer program codes for causing the computer to establish a secure communication path between the user information management device and another user information management device when the user is registered at said another user information device as a result of the search, transfer the user identification information to said another user information management device through the secure communication path so as to request the authentication of the user to said another user information management device, and receive the authentication result from said another user information management device in response.
